(19) United States
(12) Patent Application Publication
(10) Pub. No.: US 2005/0185733 A1
(43) Pub. Date: Aug. 25, 2005

(54) Data transmission method, communication system, base station and transceiver

(76) Inventors: Antti Tolli, Oulu (FI); Marian Codreanu, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/846,829

(22) Filed: May 17, 2004

(30) Foreign Application Priority Data
Feb. 20, 2004 (FI) 20040269

(51) Int. Cl. H04B 15/00

(52) U.S. Cl. 375/285

(57) ABSTRACT

A data transmission method utilizing time division duplex between a first and a second transceiver is provided. The first transceiver transmits a signal to the second transceiver using given transmission parameters. The second transceiver estimates a signal quality metric from the signal, the metric depicting signal quality degradation caused by interference. The second transceiver compares the estimated metric to a target metric, determines an offset value on the basis of the comparison, and transmits the offset value to the first transceiver, which adjusts transmission parameters on the basis of the offset value, and transmits a signal to the second transceiver using the adjusted transmission parameters.

### FIELD

The invention relates to a wireless data transmission method utilizing time division duplex between a first and a second transceiver. The invention relates especially to adjusting transmission parameters used in the data transmission.

### BACKGROUND

Communication systems, and a wireless communication system in particular, have been under extensive development in recent years. Several new services have been developed in addition to the conventional speech transmission. Different data and multimedia services are attractive to users and communication systems should provide sufficient quality of service at a reasonable cost.

The new developing services require high data rates and spectral efficiency at a reasonable computational complexity. One proposed solution is to use link adaptation techniques, where modulation, coding, and/or transmission power are dynamically adapted to the changing channel conditions. Link adaptation is especially useful if the transmitter has some knowledge about channel state prior to transmission.

In Time Division Duplex (TDD) both transmission directions on a connection between two transceivers use the same frequency channel. In such a solution the channel is the same if the channel coherence time is longer than the used frame length. Thus, channel information gathered on uplink (mobile to base station) direction may be used in downlink (base station to mobile) direction, and vice versa.

Another solution to realize high data rate services in a fading environment is a multicarrier system employing multiple antennas. In traditional wireless communication systems a connection transmits on a single frequency. In multicarrier systems each connection may use several carriers, which may be called subcarriers. The use of subcarriers increases data throughput. Both in a transmitter and in a receiver multiple antennas may be used. The use of multiple antennas provides an efficient diversity solution against fading channels. One such system is a MIMO OFDMA system, which combines MIMO (multiple input multiple output) techniques with OFDM (orthogonal frequency division multiplexing) modulation.

If TDD is used, the channel conditions may be estimated efficiently. If a channel is known at a transmitter side, a channel matrix can be decomposed for each sub-carrier using SVD (singular value decomposition). As a result a set of orthogonal sub-channels is obtained in the space domain. These elementary sub-channels are also called eigenmodes.

In time division duplex (TDD) adaptive MIMO-OFDM system modulation parameters used in uplink (UL) and downlink (DL) used in every subcarrier can be adapted according to the channel conditions measured during the previous UL/DL frame. Robust constellations can be used for subcarriers with high attenuation while high level constellations can be used for strong subcarriers in order to increase the transmission rate. It is also possible to drop some of the most attenuated subcarriers. In TDD systems the downlink channel can be estimated accurately during the previous TDD uplink frame assuming that the frame length is sufficiently shorter than the channel coherence time. However, the actual interference in downlink can be very different from the interference measured in uplink, i.e., downlink interference does not necessarily correlate with uplink interference at all. The level of interference can be very different in uplink and downlink, as well as, the interference can be colored in spatial, frequency and time domains. In that case, the modulation/coding parameters assigned on the basis of uplink measurements may lead to excessively high frame error rates, if the downlink interference is much higher than the uplink interference. Respectively, the available downlink channel capacity is not fully exploited if the uplink interference is much higher than the downlink interference. Clearly, some method to overcome the effect of non-reciprocity between uplink and downlink interference is needed.

### BRIEF DESCRIPTION OF THE INVENTION

An object of the invention is to provide an improved communication method. According to an aspect of the invention, there is provided a data transmission method utilizing time division duplex between a first and a second transceiver, the method comprising: transmitting a signal from the first transceiver to the second transceiver using given transmission parameters; the second transceiver estimating a signal quality metric from the signal received from the first transceiver, the metric depicting signal quality degradation caused by interference; the second transceiver comparing the estimated metric to a target metric; the second transceiver determining an offset value on the basis of the comparison; the second transceiver transmitting the offset value to the first transceiver; the first transceiver adjusting transmission parameters on the basis of the offset value; the first transceiver transmitting a signal to the second transceiver using the adjusted transmission parameters.

According to another aspect of the invention, there is provided a data transmission method utilizing time division duplex between a first and a second transceiver, the method comprising: the first transceiver measuring channel parameters from a signal transmitted by the second transceiver; the first transceiver selecting transmission parameters on the basis of the measurement; transmitting a signal from the first transceiver to the second transceiver using the selected transmission parameters; the second transceiver estimating a signal quality metric from the signal received from the first transceiver, the metric depicting signal quality degradation caused by interference; the second transceiver comparing the estimated metric to a target metric; the second transceiver determining an offset value on the basis of the comparison; the second transceiver transmitting the offset value to the first transceiver; the first transceiver adjusting transmission parameters on the basis of the offset value; the first transceiver transmitting a signal to the second transceiver using the adjusted transmission parameters.

According to another aspect of the invention, there is provided a communication system utilizing time division duplex and comprising at least a first and a second transceiver, the first transceiver being configured to: measure channel parameters from a signal transmitted by the second transceiver, select transmission parameters on the basis of the measurement, transmit a signal to the second transceiver using the selected transmission parameters; the second transceiver being configured to: estimate a signal quality metric from the signal received from the first transceiver, the metric depicting signal quality degradation caused by interference, compare the estimated metric to a target metric, determine an offset value on the basis of the comparison, transmit the offset value to the first transceiver; the first transceiver being further configured to: adjust transmission parameters on the basis of the offset value, and transmit a signal to the second transceiver using the adjusted transmission parameters.

According to another aspect of the invention, there is provided a base station configured to transmit and receive signals between at least one user transceiver using time division duplex, wherein the base station is further configured to: measure channel parameters from a signal received from a user transceiver; select transmission parameters on the basis of the measurement; transmit a signal to the mobile transceiver using the selected transmission parameters; receive an offset value from the user transceiver, the offset value denoting the effect of interference on the signal received by the user transceiver; adjust the transmission parameters on the basis of the offset value, and transmit a signal to the user transceiver using the adjusted transmission parameters.

According to yet another aspect of the invention, there is provided a user transceiver configured to transmit and receive signals between a base station using time division duplex, wherein the user transceiver is further configured to: receive a signal from the base station; estimate a signal quality metric from the signal received from the base station, the metric depicting signal quality degradation caused by interference; compare the estimated metric to a target metric; determine an offset value on the basis of the comparison, and transmit the offset value to the base station.

The solution of the invention provides several advantages. The capacity of the system can be utilized more efficiently in low interference conditions, and the signal quality can be kept high in high interference situations. The solution is simple to implement and does not require large investments.

In an embodiment of the invention, an offset value is applied at the transmitter. The offset value compensates the average power difference between interference of different transmission directions. For example, in cellular systems the interference may be different in uplink and downlink. Assume that a first transceiver is transmitting to a second transceiver. The power offset value is adaptively adjusted at the second transceiver on the basis of the difference between a target metric and a measured metric. The offset value is sent to the first transmitter and utilized for compensating the interference difference of the transmission directions in the transmission of the next frame. The metric can be based on for example the frame error rate (FER) or some other metric such as bit error rate (BER) or raw BER, measured at the second transceiver. The offset value can be used to adjust transmission parameters used in transmitting the signal to the second transceiver. The transmission parameters may be transmitting power, modulation parameters, coding parameters, or a combination of the above, for example.

The solution can be applied both in single carrier and in multicarrier systems. In multicarrier systems, an offset value may be determined for each subcarrier separately, in which case the frequency selective interference may be compensated accurately. In an embodiment a single offset value is determined for all subcarriers, in which case the processing and signaling feedback will be reduced significantly.

The solution is especially efficient when the interference experienced by the communication system is frequency selective, time selective and/or spatially colored interference. In such cases the interference experienced on different transmission directions varies and is difficult to compensate using prior art solutions.

### LIST OF DRAWINGS

In the following, the invention will be described in greater detail with reference to the preferred embodiments and the accompanying drawings, in which

FIG. 1 shows an example of a communication system,

FIG. 2 illustrates an example of a frame structure,

FIG. 3 is a block diagram illustrating an embodiment of the invention,

FIG. 4 is a flowchart illustrating an embodiment of the invention,

FIGS. 5A and 5B illustrate an example of a transmitter and a receiver.

### DESCRIPTION OF EMBODIMENTS

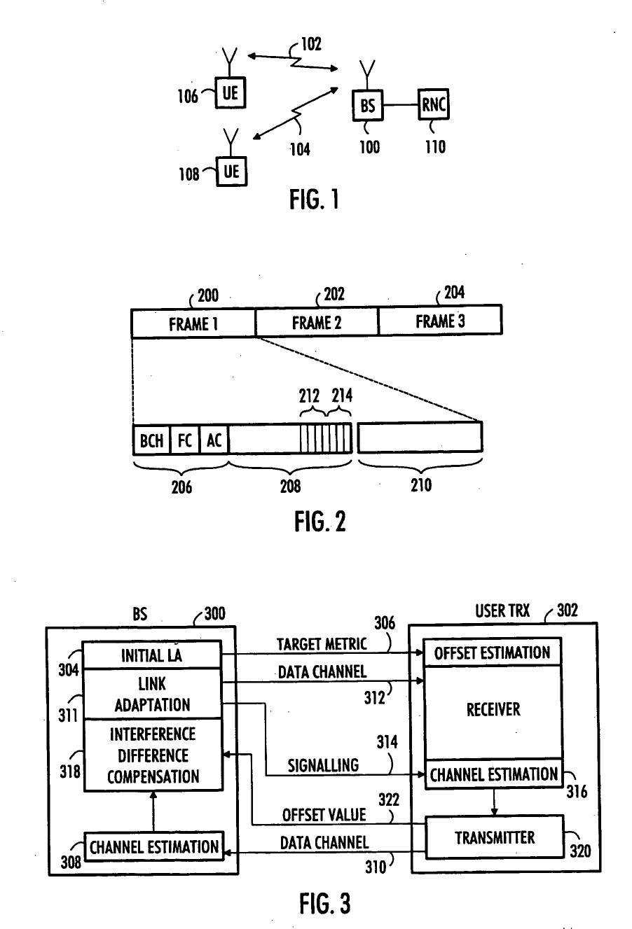

With reference to FIG. 1, we examine an example of a communication system in which embodiments of the invention can be applied. The present invention can be applied in various wireless communication systems. In the following, an embodiment of the invention is described using a wireless communication system employing adaptive MIMO-OFDM as an example. However, it should be noted that the invention is not limited to multiple antenna or multicarrier systems. A person skilled in the art may apply the solution to other systems provided with the necessary properties.

One example of a communication system employing MIMO-OFDM is IEEE 802.11 a wireless LAN communication system. The basic idea of OFDM is to split a high-rate data stream into parallel streams that are transmitted simultaneously over different orthogonal sub-carriers. An OFDM signal consists of a sum of sub-carriers that are modulated by using phase shift keying (PSK) or quadrature amplitude modulation (QAM), for example. MIMO systems include multiple transmission and reception antennas. It is clear to a person skilled in the art that the method according to the invention can be applied to systems utilizing different modulation methods or air interface standards.

In MIMO-OFDM systems, the frequency selective MIMO channel is turned into a set of frequency flat MIMO channels which can be individually processed. This reduces computational complexity. Elementary orthogonal sub-channels of each sub-carrier, obtained by using SVD (singular value decomposition) of a channel matrix at each sub-carrier, can also be called eigenmodes.

FIG. 1 is a simplified illustration of a digital data communication system to which an embodiment according to the invention is applicable. This is a part of a cellular radio system, which comprises a base station or an equivalent network element 100, which has bidirectional radio links 102 and 104 to user transceivers 106 and 108. The user transceivers may be fixed, vehicle-mounted or portable. The base station comprises transceivers which are able to establish the bidirectional radio links to the user transceivers. The base station is further connected to a radio network controller or an equivalent network element 110, which transmits the connections of the transceivers to the other parts of the network. The radio network controller controls in a centralized manner several base stations connected to it.

The cellular radio system can also communicate with other networks such as a public switched telephone network or the Internet.

If a transmitter has some knowledge about CSI (channel state information) the spectral efficiency can be increased by applying adaptive transmission techniques. In a TDD (time division duplex) based system, the channel can be estimated at the base station on the basis of a signal received in one or more selected previous uplink timeslots. The estimate may be used for link adaptation during the next down link timeslot. The link adaptation consists of modifying transmission parameters according to channel variation in order to maximize the throughput using at most the maximum transmission power and fulfilling requirements set for the reliability of the transmission. Typically, the reliability is evaluated in terms of frame error rate (FER) or bit error rate (BER).

The transmitter typically informs the receiver about the chosen transmission parameters, for instance selected eigenmodes, constellations, powers allocated to the eigenmodes and channel code parameters, using a signaling channel. The signaling overhead reduces effective capacity of the downlink channel, thus the target is to minimize it for making the usage of available capacity more efficient.

By using OFDM the power distribution can be controlled in the frequency and space domain by applying joint adaptive bit and power loading for sub-channels or eigenmodes. For example, for each transmitted frame, in order to maintain the selected frame error rate (FER) under the total transmitted power constraint, the modulation scheme and the allocated power to each eigenmode are adapted according to channel conditions.

In the embodiment of FIG. 1, a frame format transmissions and TDD are employed in the transmissions 102, 104 between the base station and the user transceivers. FIG. 2 illustrates an example of a frame format. The transmissions are divided into frames. FIG. 2 shows three successive frames 200 to 204. The structure of a frame is also illustrated in FIG. 2. Each frame comprises common time slots 206 used for example for signaling and broadcast purposes. The frame further comprises a downlink part 208 and an uplink part 210. In the downlink part 208 the base station transmits signals to the user transceivers. The figure illustrates the signals 212, 214 of two user transceivers. In the uplink part the user transceivers send their signals to the base station. In adaptive MIMO-OFDM system modulation parameters used in uplink and downlink used in every subcarrier can be adapted according to the channel conditions measured during the previous frame.

An embodiment of the invention is illustrated in the block diagram of FIG. 3. FIG. 3 shows two transceivers 300, 302. In this example, it may be assumed that the first transceiver 300 is a base station and the second transceiver is a user transceiver, though this is not necessarily the case. At the beginning of a connection, the base station determines initial link adaptation settings 304 on the basis of some prior information of the channel. The prior information may have been measured from pilot signals or prior transmissions. The base station informs 306 the user transceiver 302 about the initial settings. The initial settings comprise the target metric, such as the selected FER value target. The base station may resend the target metric whenever the parameters are changed.

Prior to transmitting a frame the base station performs channel estimation 308 from the signal 310 transmitted by the user transceiver in the previous frame. On the basis of the channel estimation the base station selects link adaptation or transmission parameters 311 so that the target metric is reached in the receiving end. The base station sends a frame to the user transceiver using the given parameters. The frame comprises a data channel 312 and a signaling channel 314. The signaling channel comprises information about the transmission parameters used in the transmission.

The receiver of the user transceiver 302 receives the frame transmitted by the base station. The user transceiver performs channel estimation 316 from the received frame. The user transceiver estimates 318 a signal quality metric from the frame received from the base station, the metric depicting signal quality degradation caused by interference. For example, the user transceiver may determine bit error rate from the received frame. As the base station took the channel condition into account in transmitting the frame, the bit errors are mainly due to interference on the downlink channel. Contrary to the channel conditions the interference is not reciprocal in different transmission directions.

In an embodiment, the user transceiver received the target FER from the base station in the beginning of the connection. The user transceiver has calculated a respective BER with which the target FER is reached. In another embodiment the base station sends directly target BER to the user transceiver. The user transceiver now compares 318 the measured BER to the target BER. If the measured BER is larger than the target BER, the base station should either use more transmission power or more robust modulation and coding parameters so that the target metric is reached. If the measured BER is smaller than the target BER, the available downlink channel capacity is not fully exploited or the transmission power used in transmitting the signal has been needlessly large. The base station could either use smaller transmission power or use more high level modulation and coding parameters to better exploit the channel.

As explained earlier, also other metrics than BER and FER may be used. In an embodiment, turbo decoding is utilized in the processing of the received signals. The user transceiver measures BER after a turbo iteration and uses this measurement as the signal quality metric which is compared to the target metric.

On the basis of the comparison an offset value is generated. The transmitter 320 of the user transceiver transmits the offset value to the base station on the uplink channel 322. In an embodiment, the offset value illustrates the difference between the measured metric and the target metric. The offset value may be the difference in decibels, for example. In an embodiment, the offset value is a coded command to change the transmission parameters. The coding is determined beforehand between the transceivers. For example, a certain value of the offset value means that the transmission power should be adjusted for a given amount, or and another value means that the modulation and coding parameters should be adjusted. The offset value may be a bit or a bit sequence.

The base station receives the offset value and performs the required compensation 318 of the downlink/uplink interference difference. The offset value may be taken into account in the above described manner when performing the link adaptation calculations for the next frame.

In an embodiment, a hysteresis value is utilized in determining the offset value. If the target metric and the measured metric differ from each other more than a predetermined hysteresis value, the offset value comprises a command to change the transmission parameters. If the difference is smaller than the predetermined hysteresis value, the offset value may comprise information that the parameters are not to be changed on the basis of the non-reciprocal interference.

In an embodiment, an initial value for the offset value is determined. Initial default value for the interference offset can be for example 0 dB, or the initial guess can be based on some rough initial measurements, or based on a parameter. For example, the receiver may perform interference measurements, and the initial value may be selected on the basis of the measured interference level. The use of an initial value may help the control algorithm to converge faster to the desired value. For example, if a stepwise up/down commands are utilized as offset values, and the initial difference between the target metric and the measured metric is large, the adjustment of the transmission parameters might take a long time. When an initial offset value command which comprises a larger change in the transmission parameters is issued, the transmitter may adjust the transmission faster.

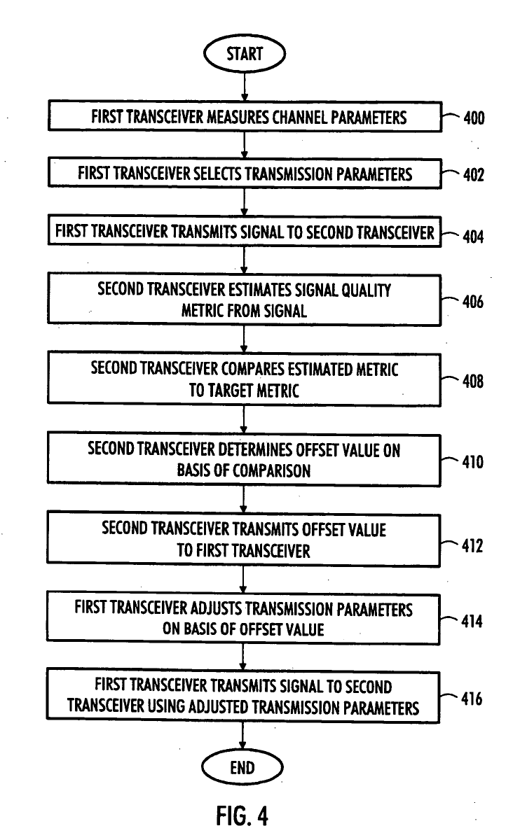

FIG. 4 illustrates an embodiment of the invention with a flowchart. The invention is applied between a first and a second transceiver.

In step 400, the first transceiver measures channel parameters from a signal transmitted by the second transceiver. In step 402 the first transceiver selects transmission parameters, such as a transmission power and modulation/coding parameters on the basis of the measurement. In step 404 the first transceiver transmits a signal to the second transceiver using the selected transmission parameters.

In step 406 the second transceiver receives the signal and estimates a signal quality metric from the signal. The metric depicts signal quality degradation caused by interference. In step 408 the second transceiver compares the estimated metric to a target metric. In step 410 the second transceiver determines an offset value on the basis of the comparison and transmits the offset value to the first transceiver in step 412.

In step 414 the first transceiver adjusts transmission parameters on the basis of the offset value and in step 416 transmits a signal to the second transceiver using the adjusted transmission parameters.

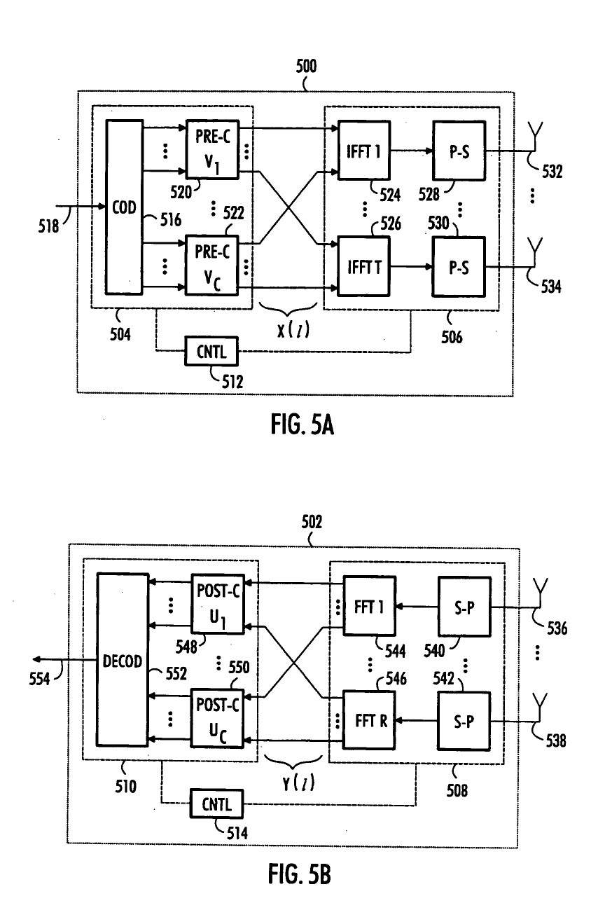

An example of the structure of a transmitter 500 of a transceiver employing adaptive TDD MIMO OFDM is illustrated in FIG. 5A. Respectively, an example of the structure of a receiver 502 of a transceiver employing adaptive TDD MIMO OFDM is illustrated in FIG. 5B. In FIGS. 5A and 5B, those components of a transmitter 500 and a receiver 502 of a transceiver which are relevant in employing MIMO OFDM are illustrated. It is clear to a person skilled in the art that a MIMO OFDM transceiver comprises also other components.

A transmitter 500 comprises a preprocessor 504 and an OFDMA modulator 506. Respectively, a receiver 502 comprises an OFDMA demodulator 508 and a postprocessor 510. The transmitter and receiver further comprise a controller 512, 514. In a transceiver, the controller may be common to the transmitter and a receiver. The controller 512 controls the operation of the preprocessor 504 and the OFDMA modulator 506. Respectively, controller 514 controls the operation of the OFDMA demodulator 508 and the post-processor 510.

The pre-processor 504 comprises a coding unit 516, which performs channel coding to the input bits 518. The preprocessor 504 performs bit and power loading. This means that the preprocessor selects suitable modulation and coding scheme as well the transmission power to be used. The pre-processor 504 further comprises linear pre-combining units 520, 522 which convey the bits (or symbols) to IFFT-blocks 524 to 526 of the OFDM modulator 506.

Assume that C sub-carriers, T transmit and R receive antennas, denoted by (C;T;R) in the following, are utilized. At each time instant, l, l=1, . . . L the preprocessor 504, which comprises channel coding, bit loading of information data bit stream and linear pre-combining, generates a T×C dimensional matrix X(l). The tth row of matrix X(l) is associated with the OFDM modulator at the transmit antenna t, t=1, . . . , T.

The OFDM modulator 506 comprises IFFT blocks 524 to 526 and, parallel to serial converters 528 to 530. The converters perform also cyclic prefix (CP) insertion to the signal. The CP is chosen to be longer than maximum excess delay of the channel to avoid the inter-symbol and inter-carrier interference. The signal is then transmitted using the T antennas 532 to 534.

The receiver 502 comprises R receive antennas 536 to 538, which receive a signal transmitted by the transmitter. The OFDM demodulator comprises serial to parallel converters 540 to 542, in which the CP is removed, then the resulted signals are serial to parallel converted. The signals are passed through FFT transformers 544 to 546. For each time instant l the OFDM demodulator generates an R×C dimensional matrix Y(l), each row in the matrix corresponding to a receiving antenna.

The postprocessor 510 of the receiver 502 comprises linear post—combining units 548 to 550 and a decoding unit 552 which performs demodulation and channel decoding and outputs the output bits 554.

Assuming perfect frequency and sample clock synchronization between the transmitted and the received signals, the input-output relation for OFDM modulator/demodulator chain can be written in the form:
y_{c}=H_{C}(l)x_{c}(l)+\sqrt{wₗ}H_{i,c}(l)χ_{c}(l)+n_{c}(l)
where c=1, . . . , C represents the subcarrier index, x_{c} (l) and y_{c} (l) denote the c:th columns in the matrices X(l) and Y(l) respectively, n_{c} (l) represents a noise vector having the covariance matrix E{n_{c}(l) n_{c}^{H} (l)}=N₀I_{R}, H_{c}(l) represents the channel's matrix of the desired user at time instant l and H_{i;c}(l) represents the channel matrix for the interference source. The entry [H_{c}(l)]_{r;t} represents the complex channel gain between transmitter antenna t and receiver antenna r at subcarrier c, while the entry [H_{i;c}(l)]_{r;t} represents the complex channel gain between transmitter antenna t of the interference source and receiver antenna r of the desired user at subcarrier c. The elements of both H_{c} (l) and H_{i;c} (l) are normalized to the unitary variances
σ_{H}²=E{|[H_{c}(l)]_{r;t}]₂}=1 and
σ_{H1}²=E{|[H_{i,c}(l)]_{r;t}]₂}=1,
respectively. The interference \sqrt{wₗ}H_{i,c}(l)χ_{c}(l) is modelled as a single source of information where the term χ_{c} represents the interference signal vector, modelled as complex Gaussian and having the same properties as the noise. The weight factor wₗ represents the average difference between the interference power I₀ and the noise power N₀, I₀/N₀. The frame length, L, is chosen to be smaller than the coherence time of the channel. The time index, l, will be skipped in the following in order to simplify the notation.

Eigenmode transmission is performed by linearly precombining and post-combining the transmitted data with unitary matrices V_{c} and U_{c}^{H}. In the case of perfect prior knowledge of channel state information (CSI) at the transmitter, V_{c} and U_{c}^{H} are obtained by singular value decomposition of channel matrix:
H_{c}=U_{c}Λ_{c}V_{c}^{H}

The channel state information may be determined by the controller 512 from the signal received by the receiver. The controller calculates a channel matrix defining the channel properties. The controller may also calculate the singular value decomposition and give the required data to the pre-processor 504. U_{c} is an R×R unitary matrix containing in its columns left singular vectors of the channel matrix. V_{c} is a T×T unitary matrix containing in its columns left singular vectors of the channel matrix. Λ_{c} is an R×T dimensional matrix having the elements \sqrt{\hat{λ}}_{l,c}, \sqrt{\hat{λ}}_{2,c} on the main diagonal and all other elements being zeros; the elements on the main diagonal are in a descending order \sqrt{\hat{λ}}_{l,c}>\sqrt{\hat{λ}}_{2,c}·λ_{i,c} means the square of the i'th singular value of the true channel matrix H_{c}.

In this way a set of r=min(T;R) orthogonal spatial subchannels are obtained at each subcarrier. The instantaneous capacity of such (C,T,R) MIMO-OFDM system is maximized by using a suitable water filling (WF) power allocation between subchannels. Water filling techniques are known in the art.

The unitary matrix V_{c} is applied to the signal to be transmitted in the linear pre-combining units 520, 522 of the transmitter 500.

Respectively, the unitary matrix U_{c}^{H} is applied to the received signal in the linear post combining units 548 to 550 of the receiver 502.

The bit and power loading performed in the preprocessor 504 on the basis of the channel information is performed in ways known to one skilled in the art. In an embodiment of the invention, the offset value is taken into account when defining the final transmission parameters.

In an embodiment, the transmission parameters are first calculated based on the channel information calculated from the received signal. The channel information is rather accurate as both transmission directions use the same frequency band. The calculated transmission parameters are further modified by taking the offset value into account. For example, when the offset value is corresponding to the interference difference between uplink and downlink, the modulation, coding and transmission power are first defined using the channel information so that the desired FER target will be reached. Then, the transmission power is adjusted upwards or downwards on the basis of the offset value. If the transmission power cannot be adjusted, then modulation and/or coding are adjusted.

In an embodiment, the transmission parameters are calculated by taking both the channel information calculated from the received signal and the offset value into account simultaneously.

Even though the invention is described above with reference to an example according to the accompanying drawings, it is clear that the invention is not restricted thereto but it can be modified in several ways within the scope of the appended claims.

1. A data transmission method utilizing time division duplex between a first and a second transceiver, the method comprising:
transmitting a signal from the first transceiver to the second transceiver using given transmission parameters;
estimating, with the second transceiver, a signal quality metric from the signal received from the first transceiver, the metric depicting signal quality degradation caused by interference;
comparing, with the second transceiver, the estimated metric to a target metric;
determining, with the second transceiver, an offset value on the basis of the comparison;
transmitting, with the second transceiver, the offset value to the first transceiver;
adjusting, with the first transceiver, transmission parameters on the basis of the offset value; and
transmitting, with the first transceiver, a signal to the second transceiver using the adjusted transmission parameters.

2. A data transmission method utilizing time division duplex between a first and a second transceiver, the method comprising:
measuring, with the first transceiver, channel parameters from a signal transmitted by the second transceiver;
selecting, with the first transceiver, transmission parameters on the basis of the measurement;
transmitting a signal from the first transceiver to the second transceiver using the selected transmission parameters;
estimating, with the second transceiver, estimating a signal quality metric from the signal received from the first transceiver, the metric depicting signal quality degradation caused by interference;
comparing, with the second transceiver, the estimated metric to a target metric;
determining, with the second transceiver, an offset value on the basis of the comparison;
transmitting, with the second transceiver, the offset value to the first transceiver;
adjusting, with the first transceiver, transmission parameters on the basis of the offset value; and
transmitting, with the first transceiver, a signal to the second transceiver using the adjusted transmission parameters.

3. The method of claim 1, further comprising:
selecting the transmission parameters to comprise at least one of transmission power, coding, and modulation.

4. The method of claim 2, further comprising:
determining in the first transceiver a target signal quality metric on the basis of the measured channel parameters; and,
transmitting the target metric to the second transceiver.

5. The method of claim 1, further comprising:
choosing the target metric to comprise at least one of a frame error rate value, a bit error rate value, and a raw bit error rate value.

6. The method of claim 1, further comprising:
selecting the offset value to include a command to change the transmission parameters when the target metric and the estimated metric differ from each other by more than a given hysteresis value.

7. The method of claim 1, further comprising:
selecting the offset value to include a command not to change the transmission parameters when the target metric and the estimated metric differ from each other by less than a given hysteresis value.

8. The method of claim 1, further comprising:
selecting the offset value to comprise a stepwise command to perform at least one of increasing transmission power and decreasing transmission power.

9. The method of claim 5, further comprising:
using the second transceiver to estimate a bit error rate of the received signal, to convert the target frame error rate value to a respective bit error rate value, and to compare the estimated bit error rate to the respective bit error rate value to produce the offset value,

10. The method of claim 1, further comprising:
using the second transceiver to measure the interference level of the received signal, and to also utilize the measured level in determining the offset value.

11. The method of claim 1, further comprising:
formatting the transmissions between the transceivers in a frame format; and
measuring, with the second transceiver, the signal quality metric for each received frame.

12. The method of claim 1, further comprising:
utilizing more than one subcarrier in the transmissions between the transceivers; and
adjusting the transmission parameters of each subcarrier separately.

13. The method of claim 1, further comprising:
utilizing more than one subcarrier in the transmissions between the transceivers; and
adjusting the transmission parameters of each subcarrier with a single offset value.

14. The method of claim 1, further comprising:
selecting the interference to be one of selective, time selective, and spatially colored.

15. A communication system utilizing time division duplex, the system comprising:
a first transceiver; and
a second transceiver, wherein the first transceiver is configured to measure channel parameters from a signal transmitted by the second transceiver,
select transmission parameters on the basis of the measurement, and
transmit a signal to the second transceiver using the selected transmission parameters, and
wherein the second transceiver is configured to
estimate a signal quality metric from the signal received from the first transceiver, the metric depicting signal quality degradation caused by interference,
compare the estimated metric to a target metric,
determine an offset value on the basis of the comparison,
transmit the offset value to the first transceiver,
the first transceiver being further configured to adjust transmission parameters on the basis of the offset value, and
transmit a signal to the second transceiver using the adjusted transmission parameters.

16. A base station configured to transmit and receive signals between itself and at least one user transceiver using time division duplex, wherein the base station is further configured to
measure channel parameters from a signal received from a user transceiver,
select transmission parameters on the basis of the measurement,
transmit a signal to the mobile transceiver using the selected transmission parameters,
receive an offset value from the user transceiver, the offset value denoting the effect of interference on the signal received by the user transceiver,
adjust the transmission parameters on the basis of the offset value, and
transmit a signal to the user transceiver using the adjusted transmission parameters.

17. The base station of claim 16, further configured to
adjust the transmission power of the signal transmitted to the user transceiver on the basis of the offset value.

18. The base station of claim 16, further configured to
adjust the modulation or coding scheme of the signal transmitted to the user transceiver on the basis of the offset value.

19. A user transceiver configured to transmit and receive signals between itself and a base station using time division duplex, wherein the user transceiver is further configured to
receive a signal from the base station,
estimate a signal quality metric from the signal received from the base station, the metric depicting signal quality degradation caused by interference,
compare the estimated metric to a target metric,
determine an offset value on the basis of the comparison, and
transmit the offset value to the base station.

20. The user transceiver of claim 19, further configured to
receive a target metric from the base station as a frame error rate value,
determine a bit error rate value corresponding to the received frame error rate value,
estimate bit error rate of the received signal,
compare the estimated bit error rate to the determined bit error rate,
determine an offset value on the basis of the comparison.

21. The user transceiver of claim 19, wherein the user transceiver is configured to determine the offset value to comprise the difference of the estimated bit error rate and the determined bit error rate.

22. The user transceiver of claim 20, wherein the user transceiver is configured to determine the offset value to comprise a command to adjust the transmission power of the base station.

23. The user transceiver of claim 20, wherein the user transceiver is configured the offset value to comprise a command to adjust the modulation or coding performed to the signal to be transmitted by the base station.

24. The user transceiver of claim 20, wherein the transceiver is configured to compare the difference of the target metric and the estimated metric to a given hysteresis value and, when the difference is larger than the hysteresis value, the user transceiver is configured to define an offset value which comprises a command to change the transmission parameters.

25. The user transceiver of claim 20, wherein the transceiver is configured to compare the difference of the target metric and the estimated metric to a given hysteresis value and, when the difference is smaller than the hysteresis value, the user transceiver is configured to define an offset value which comprises a command not to change the transmission parameters.

26. The user transceiver of claim 19, wherein the interference is at least one of frequency selective, time selective and spatially colored interference.

27. A base station configured to transmit and receive signals between at least one user transceiver using time division duplex, the base station comprising:
measuring means for measuring channel parameters from a signal received from a user transceiver;
selection means for selecting transmission parameters on the basis of the measurement;
transmission means for transmitting a signal to the mobile transceiver using the selected transmission parameters;
receiving means for receiving an offset value from the user transceiver, the offset value denoting the effect of interference on the signal received by the user transceiver;
adjusting means for adjusting the transmission parameters on the basis of the offset value; and
transmission means for transmitting a signal to the user transceiver using the adjusted transmission parameters.

28. A user transceiver configured to transmit and receive signals between a base station using time division duplex, the user transceiver comprising:
receiving means for receiving a signal from the base station;
estimating means for estimating a signal quality metric from the signal received from the base station, the metric depicting signal quality degradation caused by interference;
comparing means for comparing the established metric to a target metric;
determining means for determining an offset value on the basis of the comparison; and
transmitting means for transmitting the offset value to the base station.
